(19) United States
(12) Patent Application Publication
(10) Pub. No.: US 2024/0028877 A1
(43) Pub. Date: Jan. 25, 2024

(54) NEURAL PROCESSING UNIT FOR ATTENTION-BASED INFERENCE

(71) Applicant: Arm Limited, Cambridge (GB)

(72) Inventors: Shounak DATTA, Austin, TX (US); Dibakar GOPE, Austin, TX (US); Jesse Garrett BEU, Austin, TX (US); Mark John O'CONNOR, Luebeck (DE)

(21) Appl. No.: 17/870,038

(22) Filed: Jul. 21, 2022

(51) Int. Cl. G06N 3/063

(52) U.S. Cl. CPC G06N 3/063

(57) ABSTRACT

There is provided a neural processing unit for calculating an attention matrix during machine learning inference. The neural processing unit is configured to calculate: a first score matrix based on differences between a query matrix and a key matrix; a second score matrix based on differences between the key matrix and a learned key matrix; a similarity matrix based on a combination of the first score matrix and second score matrix; and an attention matrix comprising applying a normalisation function to the similarity matrix. Also provided is an apparatus comprising at least one said neural processing unit and at least one memory, the memory configured to pass, on demand, a learned key matrix to the neural processing unit. Also provided is a computer program product having computer readable program code stored thereon which, when executed by said neural processing unit, causes the unit to perform said calculations.

### BACKGROUND

In psychology, attention is a cognitive process of selectively concentrating on one or more things while ignoring others. A neural network can be considered an effort to mimic human brain actions. In the context of neural networks, an attention mechanism implements the action of selectively concentrating on one or more relevant things while ignoring others. This can include mathematically weighting inputs to a layer of the neural network according to a calculation performed by the attention mechanism.

### BRIEF DESCRIPTION OF THE DRAWINGS

Various embodiments of the technology described herein will now be described, by way of example only and not in any limitative sense, with reference to the accompanying drawings, in which:

FIG. 1 shows a known example of how to calculate query, key, and value matrices from an input matrix and projection matrices;

FIG. 2 shows a known example of how to calculate a similarity matrix from query and key matrices;

FIG. 3 shows a known example of how to calculate a layer of a neural network from an attention matrix and a value matrix;

FIG. 4 shows how to calculate query and key matrices from an input matrix and projection matrices according to an embodiment;

FIG. 5 shows a relationship between elements of a query matrix, elements of a key matrix, and elements of a learned key matrix in an embodiment;

FIG. 6 shows how to calculate a layer of a neural network from an attention matrix and a learned value matrix according to an embodiment;

FIG. 7 shows a hardware schematic, and instruction and data flow, between hardware elements;

FIG. 8 shows a flow chart illustrating steps of a method of operating the hardware of FIG. 7;

FIG. 9 shows a hardware schematic, and instruction and data flow, between hardware elements of an embodiment; and

FIG. 10 shows a flow chart illustrating steps embodying a method of operating the hardware of FIG. 9.

### DETAILED DESCRIPTION

A first embodiment of the technology described herein comprises a neural processing unit for calculating an attention mechanism comprising an attention matrix during machine learning inference, the neural processing unit configured to: calculate a first score matrix based on differences between a query matrix and a key matrix; calculate a second score matrix based on differences between the key matrix and a learned key matrix; calculate a similarity matrix based on a combination of the first score matrix and second score matrix; and calculate an attention matrix comprising applying a normalisation function to the similarity matrix.

A second embodiment of the technology described herein comprises an apparatus comprising at least one neural processing unit and at least one memory, the memory configured to pass, on demand, a learned key matrix to the neural processing unit, the neural processing unit for calculating an attention mechanism comprising an attention matrix during machine learning inference and configured to: calculate a first score matrix based on differences between a query matrix and a key matrix; calculate a second score matrix based on differences between the key matrix and the learned key matrix; calculate a similarity matrix based on a combination of the first score matrix and second score matrix; and calculate an attention matrix comprising applying a normalisation function to the similarity matrix.

A third embodiment of the technology described herein comprises a computer program product comprising a computer readable medium having computer readable program code stored thereon which, when executed by a neural processing unit for calculating an attention mechanism comprising an attention matrix during machine learning inference, causes the neural processing unit to: calculate a first score matrix based on differences between a query matrix and a key matrix; calculate a second score matrix based on differences between the key matrix and a learned key matrix; calculate a similarity matrix based on a combination of the first score matrix and second score matrix; and calculate an attention matrix comprising applying a normalisation function to the similarity matrix.

Some neural processing units (NPUs), such as those in the Ethos-U family of NPUs from ARM™, are unable to multiply together two matrices which are both dynamically generated at runtime (for example, input feature maps and activations in the case of convolutional neural networks), instead requiring, by virtue of their architecture, at least one of the matrices to have been pre-calculated (for example, weight matrices in the case of convolutional neural networks).

During machine learning inference, when such an NPU reaches a step wherein two dynamically generated matrices are to be multiplied together, the NPU offloads this multiplication step to another processing element capable of performing the multiplication, such as a central processing unit (CPU). As NPUs are designed to perform matrix multiplication (“matmul”) calculations more quickly than CPUs, this offloading results in a relative slowdown of the inference process.

An inference process may include the calculation of an attention matrix in a so-called attention mechanism. Attention mechanisms can require multiplication together of two dynamically generated matrices, which some NPUs are unable to perform and must offload to a CPU, as described above. Therefore, inference processes which include the calculation of an attention matrix are relatively slow compared to those which do not.

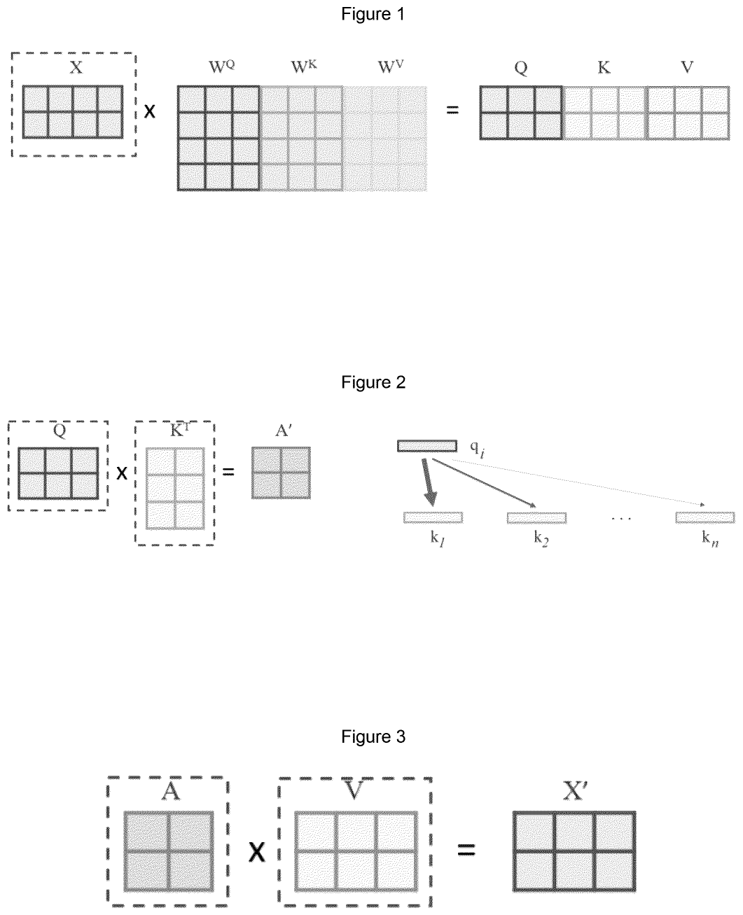

Referring to FIGS. 1, 2, and 3, a known example of calculating, during inference, an attention matrix and a layer in a neural network is described.

Referring to FIG. 1, an input matrix X is separately multiplied by a query projection matrix W^{Q}, a key projection matrix W^{K}, and a value projection matrix W^{V}, to obtain a query matrix Q, a key matrix K, and a value matrix V.

Input matrix X comprises input elements xᵢ. Query matrix Q comprises query elements qᵢ. Key matrix K comprises key elements kⱼ. Value matrix V comprises value elements vⱼ.

The dashed line surrounding input matrix X in FIG. 1 denotes that input matrix X is dynamically generated, for example at runtime. The query projection matrix W^{Q}, the key projection matrix W^{K}, and the value projection matrix W^{V}, each comprise elements which are learned in a machine learning process carried out prior to inference.

Referring to FIG. 2, the query matrix Q and a transpose of the key matrix K, denoted K^{T}, are multiplied together to obtain matrix A′. Matrix A′ is referred to as a similarity matrix. Elements a′ᵢⱼ of A′ quantitatively define a similarity between the query matrix Q and elements of the key matrix K.

In the example of FIG. 2, element k₁ is more similar to vector qᵢ than element k₂ is to vector qᵢ, and element k₂ is more similar to vector qᵢ than element kₙ is to vector qᵢ. The thickness of the arrow shown is proportional to the magnitude of the similarity.

Matrices Q and K^{T} are shown surrounded by dashed lines, indicating that both of these matrices are input-dependent and dynamically generated, for example at runtime. Therefore, some NPUs are unable to multiply them together, and must offload this step to another processing unit capable to performing the calculation, such as a CPU.

A scaling function and a softmax function may then be applied to elements a′ᵢⱼ of similarity matrix A′ to obtain a matrix A of elements aᵢⱼ. Matrix A is known as an attention matrix. The equation used to calculate elements aᵢⱼ of the attention matrix A from elements a′ᵢⱼ of similarity matrix A′ is:

$${a}_{ij} = softmax \frac{{a}_{ij}^{′}}{\sqrt{d}} ;$$

Above, d denotes the dimensionality , that is the number of columns in each of the Q, K, and V matrices.

Referring to FIG. 3, the attention matrix A and value matrix V are multiplied together to obtain a next-layer input matrix X′ for a next layer of the neural network.

Matrices A and V are shown surrounded by dashed lines, indicating that both of these matrices are input-dependent and dynamically generated, for example at runtime. Therefore, as above, some NPUs are unable to multiply them together, and those NPUs must offload this step to another processing unit capable to performing the calculation, such as a CPU.

It can therefore be seen that, during inference involving an attention mechanism, some NPUs have to offload parts of the process of calculating the attention mechanism to a different processing unit capable of performing matmul of two input-dependent, dynamically generated matrices. As processing units which are not specialized in performing matmul, such as CPUs, are slower than NPUs at performing matmul, and as this offloading requires multiple writes and reads to memory so that the NPU and other processing unit can communicate the necessary data to one another, the offloading process is not optimal. Ways of increasing inference speed and efficiency, while using less memory bandwidth and electrical power, are desirable.

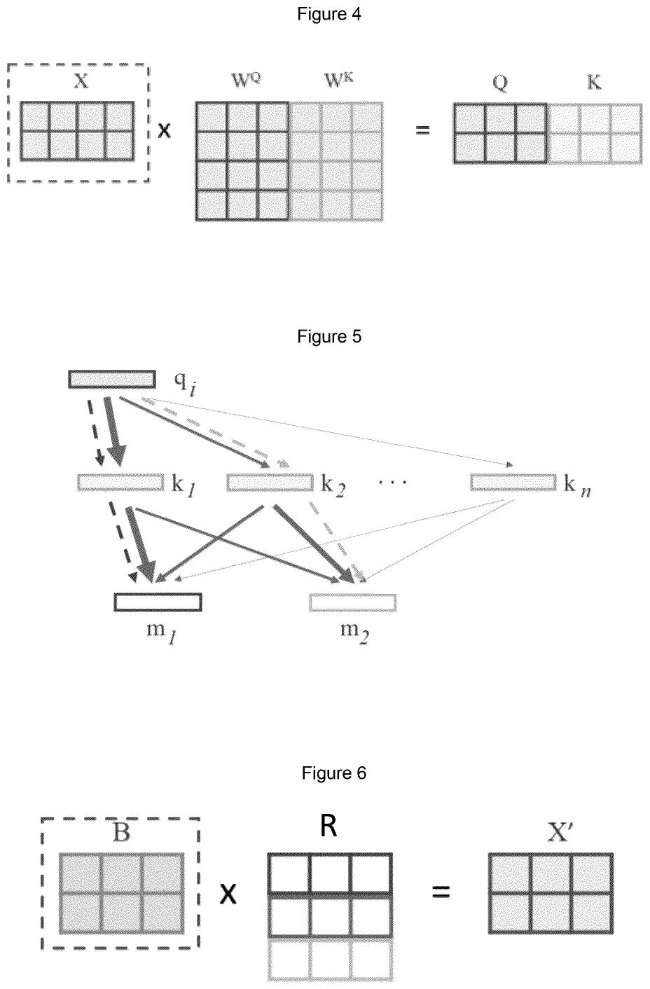

Referring to FIGS. 4 to 6, embodiments of the present technology are described.

Referring to FIG. 4, in an embodiment, an input matrix X is separately multiplied by a query projection matrix W^{Q} and a key projection matrix W^{K} to obtain a query matrix Q and a key matrix K.

Input matrix X comprises input elements xᵢ. Query matrix Q comprises query elements qᵢ. Key matrix K comprises key elements kⱼ. Learned key matrix, denoted M in embodiments of the present technology, comprises learned key elements mₖ which, in embodiments, are learned in a machine learning process carried out prior to inference. Key matrices M of embodiments of the present technology will hereon be referred to as learned key matrices with learned key elements.

The dashed line surrounding input matrix X in FIG. 4 denotes that input matrix X is dynamically generated, for example at runtime. In an embodiment, the query projection matrix W^{Q} and the key projection matrix W^{K} each comprise elements which are learned in a machine learning process carried out prior to inference.

A function of the differences between query elements and key elements is calculated to obtain one or more so-called first comparative values, denoted aᵢⱼ¹, which may also be referred to as first score values of a first score matrix.

In an embodiment, the function includes calculating one or more absolute values, or magnitudes, of the differences between the query elements and the key elements.

In an embodiment, the function includes calculating one or more summations over the differences between the query elements and the key elements.

In an embodiment, the function includes calculating one or more summations over magnitudes of differences between the query elements and the key elements according to the following equation:

$${a}_{ij}^{1} = {\sum }_{r = 1}^{d} \vert {q}_{i , r} - {k}_{j , r} \vert$$

Above, aᵢⱼ¹ are first comparative values, r denotes an r^{th} element of a matrix, d denotes the dimensionality of the matrices, and q_{i,r}, and k_{j,r} are query elements and key elements respectively.

A function of the differences between key elements and learned key elements is calculated to obtain one or more so-called second comparative values, denoted aᵢⱼ² which may also be referred to as second score values of a second score matrix.

In an embodiment, the function includes calculating one or more absolute values, or magnitudes, of the differences between the key elements and the learned key elements.

In an embodiment, the function includes calculating one or more summations over the differences between the key elements and the learned key elements.

In an embodiment, the function includes calculating one or more summations over magnitudes of differences between the key elements and the learned key elements, according to the following equation:

$${a}_{ij}^{2} = {\sum }_{r = 1}^{d} \vert {k}_{j , r} - {m}_{k , r} \vert$$

Above, aᵢⱼ² are second comparative values, r denotes an r^{th} element of a matrix, d denotes the dimensionality of the matrices, and k_{j,r}, and m_{k,r} are key elements and learned key elements respectively.

A maximization function of the first comparative values and second comparative values may be calculated to obtain so-called similarity values b′ᵢₖ of a so-called similarity matrix B′.

The maximization function satisfies the criterion that a similarity (or indeed dissimilarity, knowing that similarity and dissimilarity are inversely related) between query elements qᵢ and learned key elements mₖ depends on: sums of similarities between query elements qᵢ and key elements kⱼ; and sums of similarities between key elements kⱼ and learned key elements mₖ for the key elements kⱼ that maximize either: functions of sums of the first and second comparative values; or functions of inverses of sums of the first and second comparative values.

In an embodiment, similarity values b′ᵢₖ of a similarity matrix B′ are calculated according to the following equation:

$${b}_{ik}^{′} = {max}_{j} ( {a}_{ij}^{1} + {a}_{ij}^{2} ) \qquad ( 1 )$$

In an embodiment, similarity values b′ᵢₖ a similarity matrix B′ are calculated according to the following equation:

$${b}_{ik}^{′} = {max}_{j} ( \frac{1}{{a}_{ij}^{1} + {a}_{ij}^{2}} ) \qquad ( 2 )$$

Alternatively, rather than the specific maximization as set out above in equations (1) and (2), it is entirely possible to calculate a more general weighted sum,

In the above embodiments of equations (1) and (2), it should be noted that the property of regular attention is retained in that the similarities (or dissimilarities, knowing that similarity and dissimilarity are inversely related) represented by similarity values b′ᵢₖ between query elements qᵢ and key elements kⱼ and learned key elements mₖ are conditioned not only on input elements xᵢ of an input matrix X but also on all other input elements of the input matrix X via the key elements kⱼ.

This conditioning relationship described above is illustrated in FIG. 5, where magnitudes of similarities between elements are denoted by thicknesses of corresponding arrows therebetween. In the embodiment illustrated, key element k₁ maximizes a similarity between query elements qᵢ and learned key element m₁, while key element k₂ maximizes a similarity between query elements qᵢ and learned key element m₂.

In an embodiment, the matrix of similarity values b′ᵢₖ is normalized to calculate attention elements b′ᵢₖ of an attention matrix B, according to the following equation:

bᵢₖ=N(b′ᵢₖ )

Above, N( ) denotes a normalization function.

In embodiments, the normalization function may include one or more of, for example, a softmax function, a normalization by subtracting the mean and division by the standard deviation of the values across each row of B′, a hyperbolic tangent function, a sigmoid function, and the like.

In an embodiment, a scaling is applied to elements b′ᵢₖ, such that normalization is calculated according to the following equation:

$${b}_{ik} = N ( \frac{{b}_{ik}^{′}}{\sqrt{d}} )$$

Above, d denotes a dimensionality, that is the number of columns, of each of the Q, K, and M matrices.

Referring to FIG. 6, in an embodiment, attention matrix B and a learned value matrix R are multiplied together to obtain input matrix X′, which is an input to a next layer of a neural network. Attention matrix B is dynamically generated, for example at runtime, while learned value matrix R of learned value elements rₖ is learned prior to inference.

In an embodiment, learned value matrix R is identical to learned key matrix M.

Therefore, in embodiments of the present technology, NPUs incapable of multiplying together two or more dynamically generated matrices may be configured to calculate attention matrix B in any manner described according to any embodiment above and multiply the attention matrix B by a learned value matrix R to calculate a next layer X′ of a neural network without having to offload any steps of multiplying two dynamically generated matrices to another processing unit, such as a CPU, and to have to write to and read from a memory to do so.

In an embodiment, wherein the NPU comprises an Ethos-U processor unit from ARM™, the following table shows that replacing a first attention layer in a keyword transformer with (a) a calculation of an attention matrix B using equation (1), and (b) a calculation of an attention matrix B using equation (2).

| | |
|---|---|
| Baseline | 94.64 |
| Attention using equation (1) | 91.20 |
| Attention using equation (2) | 93.11 |

Above, “Baseline” refers to the keyword transformer architecture from the following paper: Berg, A., O'Connor, M. and Cruz, M. T., 2021. Keyword transformer: A self-attention model for keyword spotting. (arXiv preprint arXiv:2104.00769).

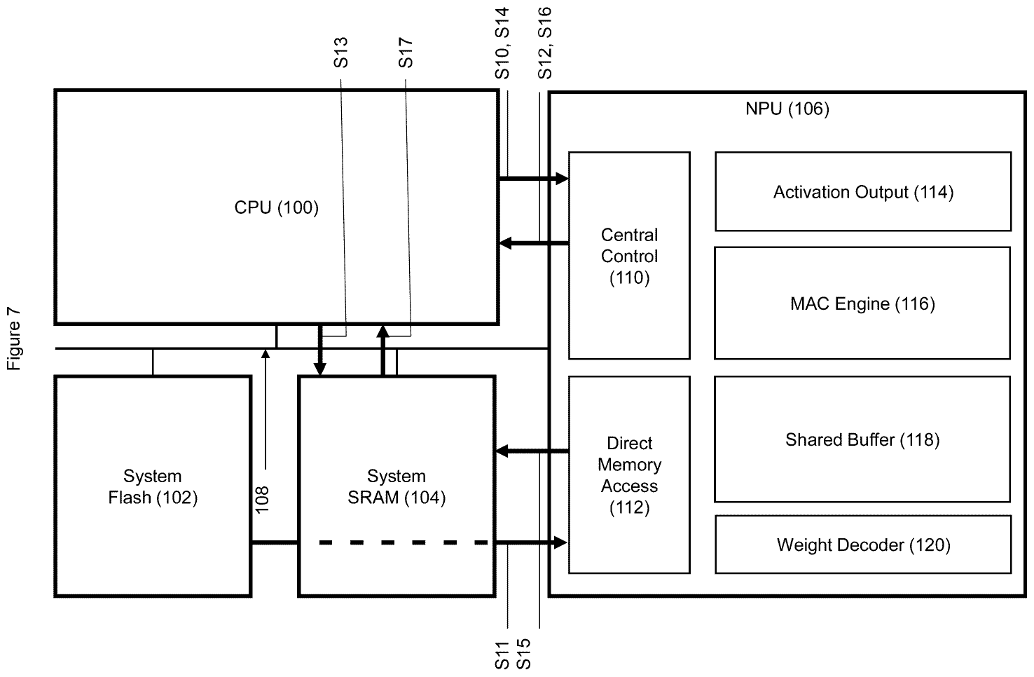

FIG. 7 shows a processing unit (100), a flash memory (102), a static RAM (104), and a neural processing unit (106), connected via an interconnect (108).

The neural processing unit (106) includes a central control element (110), a direct memory access element (112), an activation output element (114), a multiplication accumulation engine (116), a shared buffer (118), and a weight decoder (120).

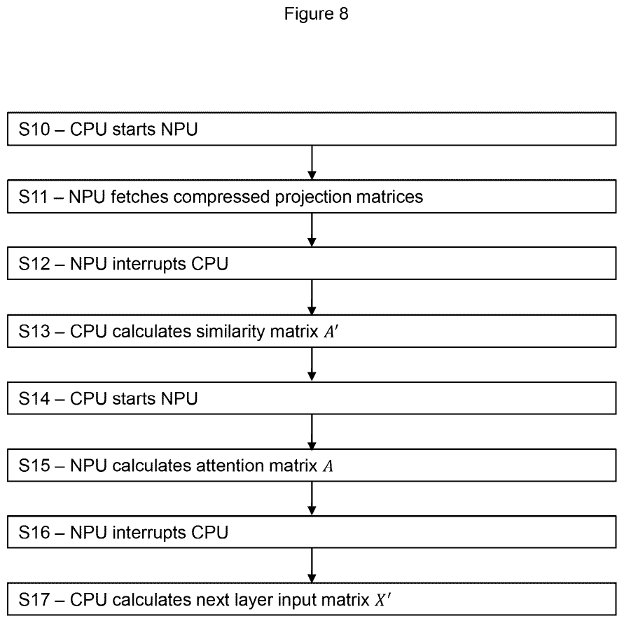

The hardware of FIG. 7, in known examples described above with reference to FIGS. 1 to 3, operates as follows, with reference to the flow chart of FIG. 8.

At stage S10, the processing unit (100) starts the NPU (106) by defining memory regions to be used, particularly the location(s) of a command stream and input activations, such as query projection matrix W^{Q}, key projection matrix W^{K}, and value projection matrix W^{V}, and input matrix X.

At stage S11, the direct memory access element (112) of the NPU (106) fetches compressed projection matrices W^{Q}, W^{K}, and W^{V} from the flash memory (102). The weight decoder (120) decodes the compressed matrices. The MAC engine (116) calculates query matrix Q, key matrix K, and value matrix V by multiplying the query projection matrix W^{Q}, the key projection matrix W^{K}, and the value projection matrix W^{V}, by input matrix X.

At stage S12, the central control element (110) of the NPU (106) interrupts the processing unit (100).

At stage S13, the processing unit (100) multiples query matrix Q by the transpose of key matrix K to obtain similarity matrix A′ (see FIG. 2).

At stage S14, the processing unit (100) starts the NPU (106) again.

At stage S15, the direct memory access element (112) obtains similarity matrix A′ from the SRAM (104). The activation output element (114) and MAC engine (116) perform a softmax function on similarity matrix A′ to obtain attention matrix A. The direct memory access element (112) outputs the attention matrix A to SRAM (104).

At stage S16, the central control element (110) of the NPU (106) interrupts the processing unit (100) again.

At stage S17, the processing unit (100) obtains attention matrix A from SRAM (104) and multiples attention matrix A by value matrix V to obtain next-layer input matrix X′ (see FIG. 3).

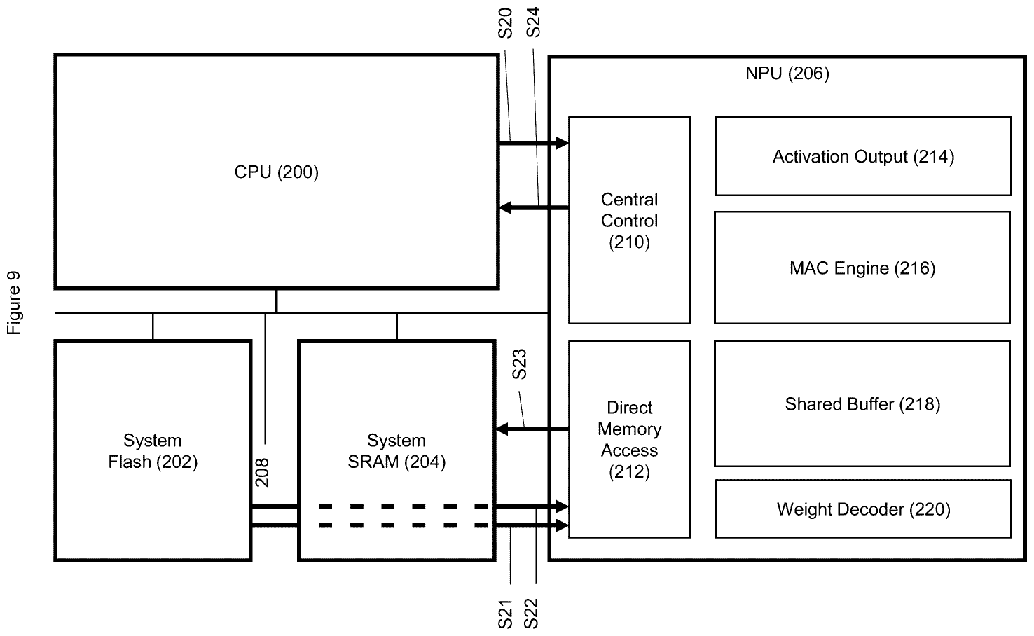

FIG. 9 shows a processing unit (200), a first memory element (202), a second memory element (204), and a neural processing unit (206), connected via an interconnect (208).

In an embodiment, the processing unit (200) is from the Cortex-M family of processing units from ARM™. In an embodiment, the first memory element (202) comprises flash memory. In an embodiment, the second memory element (204) comprises random access memory (RAM), such as static RAM (SRAM). In an embodiment, the neural processing unit (206) is from the Ethos-U family of neural processing units from ARM™.

The neural processing unit (206) may comprise a central control element (210), a direct memory access element (212), an activation output element (214), a multiplication accumulation engine (216), a shared buffer (218), and a weight decoder (220).

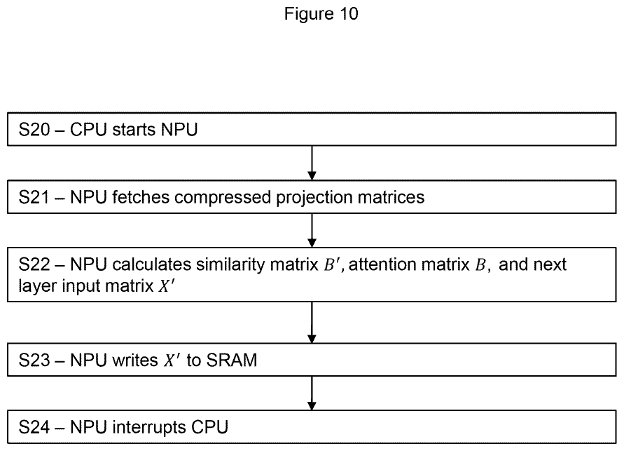

The hardware of FIG. 9, in embodiments described above with reference to FIGS. 4 to 6, operates as follows, with reference to the flow chart of FIG. 10.

At stage S20, the processing unit (200) starts the NPU (206) by defining memory regions to be used, particularly the location(s) of a command stream and input activations, such as query projection matrix W^{Q}, key projection matrix W^{K}, and input matrix X.

At stage S21, the direct memory access element (212) of the NPU (206) fetches projection matrices W^{Q} and W^{K} from the flash memory. If the matrices are compressed, the weight decoder (220) decodes them. The MAC engine (216) calculates query matrix Q and key matrix K by multiplying the query projection matrix W^{Q} and the key projection matrix W^{K} by input matrix X. The MAC engine (216) then calculates first comparative values aᵢⱼ¹ as described earlier.

At stage S22, the direct memory access element (212) of the NPU (206) fetches learned key matrix M, which comprises learned key elements mₖ and learned value matrix R. The MAC engine (216) then calculates second comparative values aᵢⱼ² using the learned key elements mₖ, and similarity matrix B′, as described earlier. The activation output element (214) and MAC engine (216) then calculate attention matrix B. The MAC engine (216) then multiplies B and learned value matrix R together to obtain input matrix X′ to the next layer of the neural network, also as described above and as shown in FIG. 6. In embodiments where learned value matrix R is identical to learned key matrix M, in other words where M is reused as a learned value matrix to calculate the next later X′, the direct memory access element (212) of the NPU (206) fetches only the learned key matrix M.

At stage S23, input matrix X′ is then written to the second memory element (204), and in an embodiment, is written to a defined SRAM buffer of the second memory element (204).

At stage S24, the NPU (206) interrupts the processing unit (200).

In an embodiment, the direct memory access element (212) prefetches the projection matrices and/or the learned key matrix and/or the learned value matrix from the first memory element (202) to a buffer, such as a scratch buffer, of the second memory element (204) if the projection matrices are to be read more than once.

In an embodiment, the direct memory access element (212) may prefetch the projection matrices and/or learned key matrix and/or learned value matrix from the first memory element (202) to the shared buffer (218).

The machine learning training required to obtain matrices M and R will now be described relative to the known method described above with reference to FIGS. 1 to 3.

For the known method described earlier, the following training steps are followed:
a. initialize the projection matrices W^{Q}, W^{K}, and W^{V} with random values sampled from a user-defined distribution, such as a Glorot normal distribution;
b. calculate attention on an input matrix X using the initialized W^{Q}, W^{K}, and W^{V} matrices;
c. output the resulting matrix X′ and pass it through subsequent layers of the neural network (if any) until a final output is obtained;
d. calculate a loss using the obtained final output and an ideal output corresponding to the input matrix X;
e. find the gradients of the calculated loss with respect to the matrices W^{Q}, W^{K}, and W^{V};
f. update the values of W^{Q}, W^{K}, and W^{V} by a small amount using gradient descent; and
g. repeat steps b-f an appropriately large number of times.

In an embodiment, machine learning training to obtain matrix M is performed as follows:
a. initialize the projection matrices W^{Q} and W^{K} and learned key matrix M with random values sampled from a user-defined distribution, such as a Glorot normal distribution;
b. calculate attention on an input matrix X using the initialized W^{Q}, W^{K}, M and R matrices;
c. Output the resulting matrix X′ and pass it through subsequent layers of the neural network (if any) until a final output is obtained;
d. calculate a loss using the obtained final output and an ideal output corresponding to the input matrix X;
e. find the gradients of the calculated loss with respect to the matrices W^{Q}, W^{K}, M, and R;
f. update the values of W^{Q}, W^{K} M, and R by a small amount using gradient descent; and
g. repeat steps b-f an appropriately large number of times.

In embodiments where M and R are identical, steps b. and e. of the training steps above are instead performed without the second matrix, i.e., without “R”.

Embodiments described herein may be applied to, for example, image classification to individuate and classify elements of an image, and to keyword spotting/transformer problems to spot keywords.

In a known keyword transformer, an input X to a first attention block in a keyword transformer is a sequence of tokens obtained by pre-processing utterance audio into a mel-scale spectrogram (which yields a 2D matrix, with one of the dimensions being temporal), then breaking these down into small non-overlapping patches along the temporal dimension, flattening the resulting 2D patches into vectors, and performing a linear projection using a learnable matrix P on each of the resulting vectors.

Q, K, and V matrices are linear projections of tokens in X, capturing different aspects of the audio corresponding to the temporal duration of each token. Examples of such aspects include frequency, loudness, semantic meaning of word(s) uttered, etc.

Attention matrix A defines a similarity between the aspects of the sequence X of tokens captured by the Q and K projections. An example of this would be tokens corresponding to related words like “wake” and “up” being assigned high mutual similarity in A.

An output X′ from the first attention block is a new set of tokens obtained as weighted combinations of the projection V of the original tokens in X, according to the similarities calculated in A. Therefore, the aspects captured by V, of the tokens which are deemed to be similar based on the aspects captures by Q and K, are mixed together in relatively higher proportions compared to tokens which are deemed not to be similar. The resulting new tokens of output X′ may undergo further processing before being fed as input to the next attention block (if any) in the subsequent part of the neural network.

In an embodiment, an input X to a first attention block in a keyword transformer is a sequence of tokens obtained by pre-processing utterance audio into a mel-scale spectrogram (which yields a 2D matrix, with one of the dimensions being temporal), then breaking these down into small non-overlapping patches along the temporal dimension, flattening the resulting 2D patches into vectors, and performing a linear projection using a learnable matrix P on each of the resulting vectors.

Q and K matrices are linear projections of tokens in X, capturing different aspects of the audio corresponding to the temporal duration of each token. Examples of such aspects of the input include frequency, loudness, semantic meaning of word(s) uttered, etc. Learned values of learned key matrix M, on the other hand, encapsulate aspects of the important abstract concepts occurring in the audio data set that the keyword transformer has been trained on.

A matrix A1 of first comparative values aᵢⱼ¹ defines a similarity between the aspects of the sequence X of tokens captured by the Q and K projections. Further, a matrix A2 of second comparative values aᵢⱼ² defines a similarity between the aspects of X captured by K and the information encapsulated in matrix M. A1 and A2 are combined to obtain the similarity matrix B between the tokens in X and the information in M. The dependence of both matrices on the K projections ensures that the similarities (to tokens in M) for each token in X are conditioned on certain aspects of the other tokens captured by K. An example would be tokens corresponding to related words like “wake” and “up” being both assigned relatively high similarities to a token in M which encapsulated the concept of “waking”.

An output X′ from the first attention block is a new set of tokens obtained as weighted combinations of the tokens in M or of tokens in learned value matrix R, according to the similarities calculated in B. Therefore, based on the aspects captured by Q and K, each token in X is replaced by a weighted combination of the concepts encapsulated by M or R to which it is deemed to be most similar. The resulting new tokens X′ may undergo further processing before being fed as input to the next attention block (if any) in the subsequent part of the neural network.

In a known image classification technique, an input X to a first attention block in a vision transformer for image classification is a sequence of tokens obtained by dividing an image into 2D non-overlapping patches, flattening the patches into vectors, and then performing a linear projection using a learnable matrix P on each of the resulting vectors.

Q, K, and V matrices are linear projections of the tokens in X, capturing different aspects of contents of corresponding image patches. Examples of such aspects include color, intensity, shapes, edges, and texture.

Matrix A defines a similarity between aspects of the sequence X of tokens captured by the Q and K projections. An example of this is tokens having similar color or containing similar shapes being assigned high mutual similarity in A.

An output X′ from the first attention block is a new set of tokens obtained as weighted combinations of the projection V of the original tokens in X, according to the similarities calculated in A. Therefore, the aspects captured by V, of the tokens which are deemed to be similar based on the aspects captures by Q and K, are mixed together in relatively higher proportions compared to tokens which are deemed not to be similar. The resulting new tokens X′ may undergo further processing before being fed as input to the next attention block (if any) in the subsequent part of the neural network.

In an embodiment, an input X to a first attention block in a vision transformer for image classification is a sequence of tokens obtained by dividing an image into 2D non-overlapping patches, flattening the patches into vectors, and then performing a linear projection using a learnable matrix P on each of the resulting vectors.

Q and K matrices are linear projections of the tokens in X, capturing different aspects of contents of corresponding image patches. Examples of such aspects of the input include color, intensity, shapes, edges, and texture. The learned key matrix M, on the other hand, encapsulates aspects of important abstract concepts from the set of images that the image classifier has been trained on.

A matrix A1 of first comparative values aᵢⱼ¹ defines a similarity between the aspects of the sequence X of tokens captured by the Q and K projections. Further, a matrix A2 of second comparative values aᵢⱼ² defines a similarity between the aspects of X captured by K and the information encapsulated in M. A1 and A2 are combined to obtain similarity matrix B between the tokens in X and the information in M. The dependence of both matrices on the K projections ensures that the similarities (to tokens in M) for each token in X are conditioned on certain aspects of the other tokens captured by K. An example is tokens corresponding to patches containing a round object being both assigned high similarities to a token in M which encapsulates the concept of “roundness”.

An output X′ from the attention block is a new set of tokens obtained as weighted combinations of the tokens in M or of tokens in learned value matrix R, according to the similarities calculated in B. Therefore, based on the aspects captures by Q and K, each token in X is replaced by a weighted combination of the concepts encapsulated by M or R to which it is deemed to be most similar. The resulting new tokens X′ may undergo further processing before being fed as input to the next attention block (if any) in the subsequent part of the neural network

It can therefore be seen that the presently described technology achieves a result as accurate, or almost as accurate, as known techniques without the downside of offloading multiplications of dynamically generated matrices to other processing units, thereby achieving those results more quickly, with less memory usage and requiring less electrical power.

An apparatus embodying the present technology includes a neural processing unit (NPU). The apparatus includes a memory. The memory may include volatile memory (e.g. SRAM, DRAM, etc.) and/or non-volatile memory (e.g. flash memory, non-volatile RAM, etc.). The apparatus may include more than one memory.

Other embodiments may also include one or more of: a central processing unit (CPU), a graphics processing unit (GPU), an apparatus-on-chip, an application specific integrated circuit (ASIC), a further neural processing unit, a DSP (digital signal processor), and the like. Any of these may be communicatively coupled to the memory for communication with the NPU, and/or to the NPU.

A neural processing unit of an embodiment may comprise and/or be in communication with a storage apparatus, such as a hard disk drive, solid state drive, network attached storage, a flash memory device, or the like.

In an embodiment, a memory stores computer program code which, when executed by the neural processing unit, causes the apparatus to perform a method embodying the present technology as described above.

Furthermore, the present techniques may take the form of a computer program product embodied in a computer readable medium having computer readable program code embodied thereon. The computer readable medium may be a computer readable signal medium or a computer readable storage medium. The computer readable storage medium may be a non-transitory computer readable storage medium encoded with instructions that, when performed by a neural processing unit, cause performance of the calculating of the attention mechanism described above. A computer readable medium may be, for example, but is not limited to, an electronic, magnetic, optical, electromagnetic, infrared, or semiconductor apparatus, system, or device, or any suitable combination of the aforementioned.

As will be appreciated by one skilled in the art, the present techniques may be embodied as an NPU, an apparatus, a computer program product, and a method. Further, embodiments of the present techniques include the training methods described above. Accordingly, the present techniques may take the form of an entirely hardware embodiment, an entirely software embodiment, or an embodiment combining software and hardware.

Computer program code for carrying out operations of the present techniques may be written in any combination of one or more programming languages, including object-oriented programming languages and conventional procedural programming languages.

For example, program code for carrying out operations of the present techniques may comprise source, object, or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on a user's computer, partly on the user's computer and partly on a remote computer or entirely on the remote computer or server. In the latter scenario, the remote computer may be connected to the user's computer through any type of network. Code components may be embodied as procedures, methods, or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer apparatus or network to perform all the steps of the method.

In a further alternative, the preferred embodiment of the present techniques may be realized in the form of a data carrier having functional data thereon, said functional data comprising functional computer data structures to, when loaded into a computer apparatus or network and operated upon thereby, enable said computer apparatus to perform all the steps of the method.

It will be clear to one skilled in the art that many improvements and modifications can be made to the foregoing exemplary embodiments without departing from the scope of the present techniques.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

1. A neural processing unit for calculating an attention mechanism comprising an attention matrix during machine learning inference, the neural processing unit configured to:
calculate a first score matrix based on differences between a query matrix and a key matrix;
calculate a second score matrix based on differences between the key matrix and a learned key matrix;
calculate a similarity matrix based on a combination of the first score matrix and second score matrix; and
calculate an attention matrix comprising applying a normalisation function to the similarity matrix.

2. The neural processing unit of claim 1, further configured to calculate at least one input to a layer of a neural network by multiplying together at least one element of the attention matrix and at least one element of a learned value matrix.

3. The neural processing unit of claim 2, wherein the learned value matrix is identical to the learned key matrix.

4. The neural processing unit of claim 1, wherein the combination comprises calculating weighted values.

5. The neural processing unit of claim 1, wherein the combination comprises maximization.

6. The neural processing unit of claim 1, further configured to multiply together an input matrix and a query projection matrix to obtain the query matrix.

7. The neural processing unit of claim 1, further configured to multiply together an input matrix and a key projection matrix to obtain the key matrix.

8. The neural processing unit of claim 1, wherein calculating the first score matrix comprises calculating at least one sum of absolute values of differences between elements of the query matrix and elements of the key matrix.

9. The neural processing unit of claim 1, wherein calculating the second score matrix comprises calculating at least one sum of absolute values of differences between elements of the key matrix and elements of the learned key matrix.

10. The neural processing unit of claim 1, wherein calculating the similarity matrix comprises calculating maxima of a sum of the first score matrix and the second score matrix.

11. The neural processing unit of claim 1, wherein calculating the similarity matrix comprises calculating maxima of a reciprocal of a sum of the first score matrix and the second score matrix.

12. The neural processing unit of claim 1, wherein the normalisation function comprises at least one of: a softmax function; a normalization by subtracting a mean and dividing by a standard deviation; a hyperbolic tangent function; and a sigmoid function.

13. The neural processing unit of claim 1, further configured to apply a scaling function to the similarity matrix based on one or more dimensions of the similarity matrix.

14. The neural processing unit of claim 1, wherein the neural processing unit comprises an Ethos-U processor.

15. The neural processing unit of claim 1, comprising a direct memory access element configured to fetch the learned key matrix and/or the learned value matrix from a memory external to the neural processing unit.

16. The neural processing unit of claim 14, wherein the direct memory access element is configured to prefetch the learned key matrix and/or learned value matrix from the memory to a buffer.

17. The neural processing unit of claim 15, wherein the buffer is a further memory external to the neural processing unit.

18. The neural processing unit of claim 15, wherein the buffer is a scratch buffer.

19. The neural processing unit of claim 15, wherein the neural processing unit comprises a shared buffer, and wherein the buffer is the shared buffer.

20. The neural processing unit of claim 14, wherein the neural processing unit is further configured to calculate at least one input to a layer of a neural network by multiplying together at least one element of the attention matrix and at least one element of the learned value matrix, and wherein the direct memory access element is configured to write the calculated at least one input to the memory external to the neural processing unit.

21. The neural processing unit of claim 1, comprising a multiplication accumulation engine configured to calculate at least one of the first score matrix and the second score matrix.

22. The neural processing unit of claim 20, wherein the multiplication accumulation engine is configured to calculate at least one input to a layer of a neural network by multiplying together at least one element of the attention matrix and at least one element of the learned value matrix.

23. The neural processing unit of claim 20, comprising an activation output element configured to, together with the multiplication accumulation engine, calculate the attention matrix.

24. An apparatus comprising at least one neural processing unit and at least one memory, the memory configured to pass, on demand, a learned key matrix to the neural processing unit, the neural processing unit for calculating an attention mechanism comprising an attention matrix during machine learning inference and configured to:
calculate a first score matrix based on differences between a query matrix and a key matrix;
calculate a second score matrix based on differences between the key matrix and the learned key matrix;
calculate a similarity matrix based on a combination of the first score matrix and second score matrix; and
calculate an attention matrix comprising applying a normalisation function to the similarity matrix.

25. A computer program product comprising a computer readable medium having computer readable program code stored thereon which, when executed by a neural processing unit for calculating an attention mechanism comprising an attention matrix during machine learning inference, causes the neural processing unit to:
calculate a first score matrix based on differences between a query matrix and a key matrix;
calculate a second score matrix based on differences between the key matrix and a learned key matrix;
calculate a similarity matrix based on a combination of the first score matrix and second score matrix; and
calculate an attention matrix comprising applying a normalisation function to the similarity matrix.
